(19) United States
(12) Patent Application Publication
(10) Pub. No.: US 2004/0160028 A1
(43) Pub. Date: Aug. 19, 2004

(54) Vehicular steering gear-box stiffener

(76) Inventors: Darin H. Tessier, Weybum (CA); Marvin Glenn Windecker, Weybum (CA)

Correspondence Address: Marvin Windecker, PO Box 173, Weybum, SK, S4H2J9, CA

(21) Appl. No.: 10/774,655

(22) Filed: Feb. 9, 2004

(30) Foreign Application Priority Data
Jan. 29, 2003 (CA) 2,418,392

(51) Int. Cl. B62D 1/00; B60G 1/00; B60P 1/00

(52) U.S. Cl. 280/93.515

(57) ABSTRACT

This invention is designed as an accessory for vehicles which provides added road feel and reduced steering wander. It provides additional support to the sector shaft in a vehicle steering gear-box by adding an outboard support bearing below the pitman arm. It is typically comprised of an additional crossmember, replacement sector shaft nut, bearing assembly and mounting plates. The outboard bearing reduces play and flex in the sector shaft, and thus improves vehicle handling.

### DESCRIPTION OF THE INVENTION

### 1. FIELD OF THE INVENTION

The present invention relates generally to vehicular steering systems, and in particular is concerned with the purpose of eliminating or reducing the effects of excessive play in the sector shaft bearing(s) of the steering box used in trucks and other automobiles, and also to reduce or eliminate frame flexure at the steering box mounting point. This invention will also reduce or eliminate flexure of the sector shaft itself. This invention will particularly benefit trucks and four-wheel drive vehicles, especially vehicles which have a large amount of drop in the steering arm. It will also be effective in reducing the undesirable consequences of larger than normal tire and wheel combinations often used on off-road and high-performance vehicles.

### 2. SUMMARY OF THE INVENTION

This invention is primarily composed of an additional bearing added to the steering box sector shaft outboard of the steering arm. Said bearing is attached to the sector shaft by means of a replacement nut which is manufactured with an integral shaft extension. This bearing is supported by a suitable mounting plate which is in turn connected to an additional cross-member which spans the vehicle's frame rails. The steering load applied to the steering arm will be borne in part by both vehicle frame rails and will reduce the forces applied to the steering box mounting area.

### 3. DESCRIPTION OF THE DRAWINGS

FIG. 1 is a view of a typical steering gear box mounted to the frame rail of a vehicle.

FIG. 2 shows a steering box equipped with this invention.

FIG. 3 shows the replacement nut which secures the pitman arm to the sector shaft and allows fixing of an outboard bearing to the sector shaft.

FIG. 4 is a view of a conventional nut of the type normally used to secure the pitman arm to the sector shaft.

FIG. 5 is a view of a common self aligning bearing unit as may be used in this invention.

FIG. 6 is a view from the underside of a vehicle which shows the complete invention mounted to the vehicle frame rails.

### 4. DESCRIPTION OF THE RELATED ART

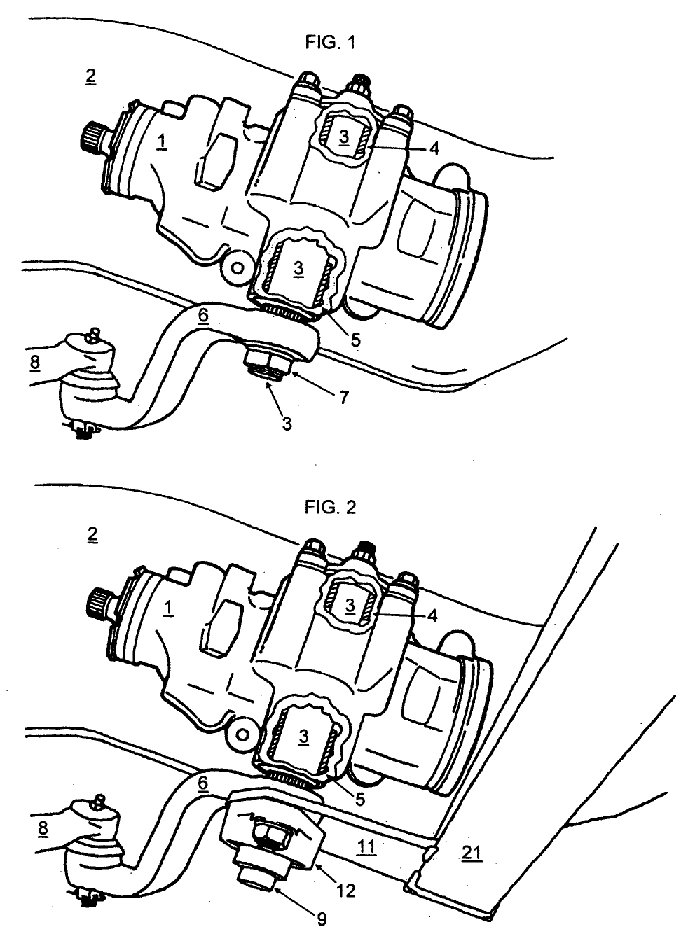

Conventional vehicular steering systems include a steering gear-box generally indicated best at 1 in FIG. 1 which is bolted to the vehicle frame rail 2 in FIG. 1. In this conventional arrangement, the steering arm or Pittman arm 6 is attached by means of a hexagonal nut 7 to the steering box sector shaft 3. A tie-rod 8 is attached to the steering arm 6 to communicate steering input and feedback to and from the remainder of the steering system respectively. This sector shaft 3 is supported in the steering box housing by an arrangement of bushings or rolling element bearings at 4 and 5. This arrangement naturally results in a cantilevered load being applied to the sector shaft 3 and its bearings or bushings at 4 and 5. This cantilevered arrangement will result in any bearing wear or operating clearance being magnified by the often large axial displacement of the tie-rod 8 mounting point on the steering arm 6 with respect to the steering box bearings 4 and 5. Additionally, all forces communicated to and from tie-rod 8 are borne solely by the one frame rail 2 that carries the steering box. Steering control and road feel are dependent on the torsional rigidity of said section of frame rail.

### 5. DETAILED DESCRIPTION OF THE INVENTION

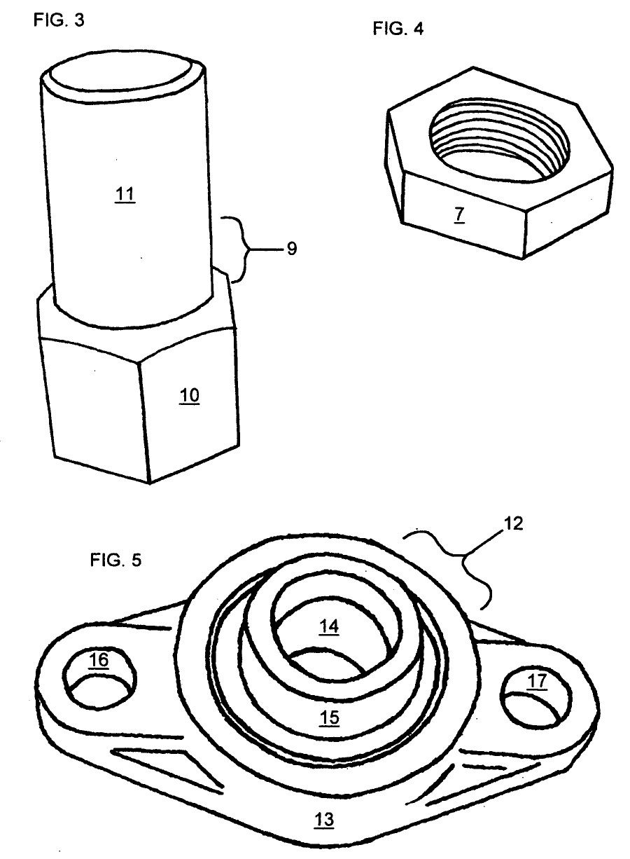

The preferred embodiment of the invention involves adding an additional support bearing to the sector shaft. This is best shown in FIG. 2. The aforementioned hexagonal nut 7 in FIG. 1 and also shown in FIG. 4, which attaches the steering arm 6 to the sector shaft 3, is removed and replaced with a replacement nut 9 best shown in FIG. 2 and FIG. 3. This nut 9 comprises one of the parts of this invention. This nut 9 is comprised of an internally threaded portion 10 to accommodate the sector shaft threads, and a cylindrical portion 11 extending from the said threaded portion 10. Said cylindrical portion 11 must be in axial alignment with said threaded portion 10 and as a result will also be in axial alignment with the sector shaft 3 when installed. The purpose of said extending cylindrical portion is to allow the fixing of an additional bearing or bushing assembly 12 best shown in FIG. 2 and FIG. 5. This said replacement nut 9 is designed with limited strength at the junction of the said threaded portion 10 and said cylindrical portion 11 to allow the said cylindrical portion 11 to shear off in the event of a collision and not cause harm to the existing steering gear.

A detailed view of a complete ball bearing assembly mounted in a bearing holder is shown in FIG. 5. This assembly is comprised of a holder 13, bearing 14, locking ring 15, and mounting holes 16 and 17. The bearing outside diameter and housing bore are machined in a spherical arrangement so as to permit a variation in perpendicularity of the bearing axis with respect to the holder mounting surface. These bearings are commonly available at industrial or agricultural supply houses.

In FIG. 2 we see the steering box 1, the sector shaft 3, steering arm 6, with the new nut 9 securing the steering arm 6. The bearing assembly 12 is shown affixed to the nut 9 and also bolted to bearing mounting plate 11. The bearing mounting plate 11 is attached to a new cross-member 21 which spans both vehicle frame rails 2 and 18.

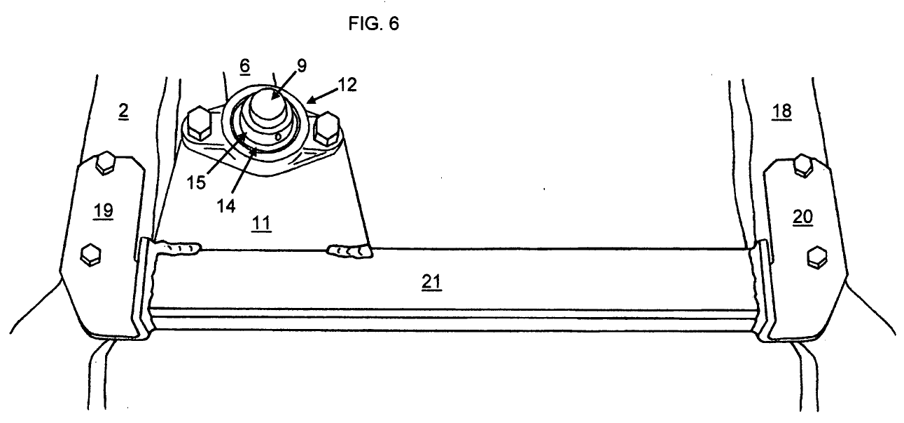

The complete mounting arrangement is best viewed in FIG. 6. The new cross-member 21 and bearing mount plate 11 may be welded directly to the frame rails 2 and 18 or may be bolted to the frame rails 2 and 18. This cross-member may constructed of material of any suitable cross-section. Material with square cross-section is shown in FIG. 2 and FIG. 6 but this invention is not limited to said square cross-section. Round, angle, channel, flat or other cross-sections may be used. A bolt on attachment may be facilitated with the aid of suitable mounting brackets 19 and 20. These brackets may be arranged to allow use of existing bolt-holes provided on the vehicle frame rails or additional holes may be drilled to facilitate mounting. These intermediary brackets 19 and 20 may also be directly welded to the vehicle frame rails 2 and 18. The brackets 19 and 20 (FIG. 6) are one example of such a bolt-on arrangement. Another embodiment of this invention involves the use of a one piece cross-member and bearing mounting area formed or stamped from flat stock, or forged or cast to the required shape. Another embodiment consisting of a cross-member constructed with an integral bearing holder would obviate the need for the separate bearing holder.

While preferred embodiments of this invention have been disclosed herein, many modifications thereof are feasible in order to accommodate various vehicles. This invention is not to be restricted except to the extent necessitated by the prior art.

The embodiments of the invention in which an exclusive property or privilege is claimed are defined as follows:

1. A steering gear-box stiffener for use with a vehicle equipped with a “re-circulating ball” or “worm and sector” steering gear-box, consisting essentially of an outboard bearing to support the said gear-box sector shaft, a means of attaching said bearing to the said sector shaft by the use of a replacement sector-shaft nut, a means of securing said bearing to the vehicle frame in the proper location by the use of a mounting arrangement generally comprised of a bearing mounting plate and crossmember rigidly attached and spanning the vehicle frame rails.

2. A stiffener as described in claim 1, in which said bearing mounting plate is attached to an existing vehicle crossmember

3. A stiffener as described in claim 1, in which the said crossmember is welded to the said frame rails.

4. A stiffener as described in claim 1, in which the said crossmember is bolted to the said frame rails.

5. A stiffener as described in claim 1, in which the said crossmember is attached to the said frame rails by means of intermediary brackets suitably attached to the said frame rails.

6. A stiffener as described in claim 1, 2, 3, 4, or 5, in which the said mounting arrangement is constructed of carbon steel, stainless steel, or aluminum.

7. A stiffener as described in claim 6, in which the said bearing mounting plate and said crossmember are formed or cast integrally.

8. A stiffener as described in claim 6 or 7, in which the said bearing is of a self-aligning type.

9. A stiffener as described in claim 6 or 7, in which said bearing is fixed.

10. A stiffener as described in claim 8 or 9, in which the said replacement sector shaft nut is constructed with an integral portion to facilitate connection with said bearing.

11. A stiffener as described in claim 10, in which said replacement sector shaft nut is constructed of carbon steel, or stainless steel.

12. A stiffener as described in claim 11, in which the said replacement sector shaft nut is constructed with a reduced cross section to facilitate breakage of said nut in a collision to avoid damage of existing steering gear.

13. A stiffener as described in claim 9, in which said bearing is designed to mate directly with the existing sector shaft nut or sector shaft directly, obviating the need for the said replacement sector shaft nut.
